(19) United States
(12) Patent Application Publication
(10) Pub. No.: US 2003/0011668 A1
(43) Pub. Date: Jan. 16, 2003

(54) Ink container, inkjet printing apparatus, and ink supplying method

(76) Inventor: Masahito Yoshida, Saitama (JP)

Correspondence Address: FITZPATRICK CELLA HARPER & SCINTO, 30 ROCKEFELLER PLAZA, NEW YORK, NY, 10112, US

(21) Appl. No.: 10/171,648

(22) Filed: Jun. 17, 2002

(30) Foreign Application Priority Data
Jun. 18, 2001 (JP) 183743/2001(PAT.)

(51) Int. Cl. B41J 2/175

(52) U.S. Cl. 347/86; 347/85

(57) ABSTRACT

A structure which includes a container for reserving a predetermined amount of ink to be supplied to a printing head and in which a supply system is configured such that ink is intermittently supplied to the container from an ink tank makes it possible to reduce the time for charging the container with ink. A member for holding ink and generating a negative pressure is provided in the container. With connecting the tank and the member, the pressure in the container is reduced to cause the member to expand, thereby introducing ink into the same. This introduction is stopped by regulating the expansion with a displaceable unit which expands when the pressure is reduced. The regulation is performed at such a position that the negative pressure generated in the member by canceling regulation is in equilibrium with an ink meniscus holding ability of the printing head.

This application is based on Patent Application No. 2001-183743 filed Jun. 18, 2001 in Japan, the content of which is incorporated hereinto by reference.

### BACKGROUND OF THE INVENTION

1. Field of the Invention

The present invention relates to an ink container, an inkjet printing apparatus utilizing the ink container, and an ink supplying method and, more particularly, the invention is preferably applied to an inkjet printing apparatus in which ink is intermittently supplied to a printing head for ejecting ink.

2. Description of the Related Art

Inkjet printing apparatuses which form an image on a printing medium by depositing ink to the printing medium using an inkjet printing head include that which form an image by ejecting ink while moving a printing head relative to a printing medium and that which form an image by ejecting ink while moving a printing medium relative to a fixed printing head conversely.

There are two general types of methods of supplying ink to a printing head used in such an inkjet printing apparatus. One is a type in which a supply system is configured such that an amount of ink is always or continuously supplied to a printing head according to the amount of ink ejected (hereinafter referred to as a continuous supply type), and the other is a type in which a printing head is provided with a reservoir (sub-tank or second ink tank) for reserving a predetermined amount of ink and in which a supply system is configured such that ink is supplied to the reservoir from an ink supply source (main tank or first ink tank) at appropriate timing or intermittently (hereinafter referred to as an intermittent supply type).

The continuous supply type is further categorized into two types, for example, when it is used in an inkjet printing apparatus of a type referred to as a serial type in which a printing head is scanned back and forth in predetermined directions relative to a printing medium and in which the printing medium is transported in a direction substantially orthogonal thereto to form an image One is a type referred to as an on-carriage type in which ink is supplied by integrally or detachably attaching an ink tank to a printing head that is carried and moved back and forth (main scanning) by a carriage. The other is a tube supply type in which an ink tank that is separate from a printing head carried on a carriage is fixedly installed in a part of a printing apparatus other than the printing head and in which the ink tank is connected to the printing head through a flexible tube to supply ink. In some of the latter type, a second ink tank that serves as an intermediate tank between an ink tank and a printing head is mounted on the printing head or the carriage.

When an on-carriage type structure is adopted, there are limits on the project area in a direction perpendicular to the main scanning direction and volume of members that move with a carriage (a printing head and an ink tank undetachably or detachably integrated with the same). Therefore, only an ink tank having a very limited capacity can be used when a small-sized printing apparatus, especially, a portable printing apparatus is to be formed. This results in very frequent replacement of the printing head integral with the ink tank or the ink tank alone, which has been problematic from the viewpoint of operability and is running cost. Further, the recent spread of so-called mobile apparatus is remarkable and, for example, ultra-compact inkjet printers have been proposed which can be integrated with notebook type personal computers and digital cameras. It is considered impractical to design such printers in adaptation to the on-carriage method.

When a tube supply type structure is adopted, although members that move with a carriage during main scanning can be made compact to some degree, it is difficult to make the apparatus as a whole compact because a space is required for a tube member to move to follow up the carriage, the tube member coupling a printing head on the carriage and an ink tank located outside the carriage to supply ink. Further, the recent trend is that a carriage is scanned at a high speed to accommodate increases in the speed of printing operations, and resultant severe rocking of a tube that follows the carriage results in changes in the pressure of ink in an ink supply system for the printing head. It is therefore required to provide various complicated pressure buffering mechanisms in order to suppress pressure changes, it has been difficult to achieve a size reduction in this respect too.

On the contrary, in the case of the intermittent supply method that is used for serial type inkjet printing apparatus for example, a relatively small second ink tank and printing head are provided on a carriage; a relatively large first ink tank is provided in a part other than the carriage of the printing apparatus; and a supply system is configured such that ink is supplied from the first ink tank to the second ink tank at appropriate timing. A structure is also employed in which the ink supply system between the first and second ink tanks is spatially separated or the ink channel is blocked with a valve during main scanning to achieve fluid isolation between the first and second ink tanks. Basically, this makes it possible to solve various problems attributable to the size of moving members as described above such as an ink tank and the rocking of a tube that have limited efforts to achieve a small size in the case of the continuous supply type.

When an intermittent supply type structure is adopted, however, it is important to adjust the pressure inside a second ink tank properly, because a negative pressure relative to the atmosphere must be generated in order to maintain ink meniscuses formed at ejection openings. While the second ink tank may be located in a position lower than the position of ejection openings of the printing head to generate a negative pressure in the second ink tank naturally, this puts a limit on even the position and attitude or orientation of the ink tank and has resulted in problems including leakage of ink from the ejection openings especially in case that a portable printing apparatus is to be provided which is unstable in attitude or orientation during transportation.

Under such circumstances, proposals have been made including a proposal in which a porous member such as a sponge for holding ink is contained a second ink tank to generate an adequate negative pressure. Such a structure is advantageous even for a portable printing apparatus whose attitude is unstable during transportation. However, the ink containing efficiency of the second ink tank is limited by the negative pressure generating mechanism such as a porous member provided in the second ink tank. Further, designing may be limited with respect to the endurance of the porous member against deposition and deterioration of a dye or pigment in ink, which also reduces freedom in selecting ink.

Further, in such a structure, since the porous member is always over-charged with ink when ink charging is completed, the over-charged ink in the porous member must be discharged as waste ink without fail by performing an operation of sucking the printing head through the ejection openings after the charging is completed in order to apply a required negative pressure to the printing head. That is, a problem arises in that a charging operation is accompanied by the generation of waste ink.

### SUMMARY OF THE INVENTION

The invention was made taking the above problems into consideration, and it provides a structure in which an intermittent supply system is adopted as an ink supply system; waste of ink such as generation of waste ink associated with a charging operation will not fundamentally occur; high charging efficiency and a short charging time is achieved; and endurance of ink can be easily maintained, i.e., a structure with which freedom in selecting ink can be increased.

The invention thus contributes to the structure of a compact and portable inkjet printing apparatus.

In a first aspect of the present invention, there is provided an ink container that can be disposed halfway of an ink supply path connecting a printing head for performing printing by ejecting ink and an ink tank serving as a source of ink to be supplied to the printing head. comprising:

an ink containing body capable of containing ink introduced thereto from the ink tank in a state in which it is in fluid communication with the ink tank, the ink containing body supplying the ink contained therein to the printing head during printing and having a flexible structure whose internal volume can be increased as a result of expansion to introduce ink therein and which can generate a negative pressure;

a housing having an inner space in which a pressure can be adjusted, the housing allowing the ink containing body to be contained in the space and allowing the expansion thereof in accordance with depressurization; and

regulating means provided in the housing such that it can regulate the expansion of the ink containing body, wherein the regulating means is configured to regulate the expansion so as to satisfy an equation:

Pst=Nt

where Pst represents the negative pressure generated by the ink containing body and Nt represents an ability to hold meniscuses formed at an ink ejecting portions of the printing head.

The regulation performed by the regulating means may be cancelled to allow the ink containing body to expand and generate the negative pressure, thereby satisfying the equation. The ink containing body may have a member having an end attached to an inner wall of the housing and another end that can be displaced according to the expansion; the member can be put in fluid communication with the ink tank through channel extending through the wall of the housing and the end; and an abutting section whose displacement is regulated by the regulating means may be provided at the other end The ink containing body may be provided with a spring for generating the negative pressure by urging the other end of the member in the direction of expanding of the member.

In a second aspect of the present invention, the regulating means has a regulating member which can expand to a predetermined position according to depressurization of the inner space of the housing and which abuts on the abutting section of the ink containing body as a result of the expansion to regulate the displacement of the same.

In a third aspect of the present invention, there is provided an inkjet printing apparatus for performing printing by using a printing head for ejecting ink, an ink tank serving as a source of ink to be supplied to the printing head, and an ink container provided halfway of an ink supply path connecting the printing head and the ink tank according to the above second aspect, the apparatus comprising:

channel opening and closing means for establishing and blocking fluid communication between the ink tank and the ink containing body; and

pressure adjusting means for reducing the pressure in the inner space of the housing in the communicated state to increase the internal volume of the ink containing body and to expand the regulating member and for canceling the depressurized state after the regulation is performed.

In a fourth aspect of the present invention, there is provided an inkjet printing apparatus utilizing an ink tank capable of containing ink to be supplied to a printing head for performing printing by ejecting ink and an ink container containing an ink containing body which can contain ink therein and whose internal volume can be changed to generate a negative pressure, the apparatus comprising:

pressure adjusting means for reducing the pressure in the ink container in a state in which it is in fluid communication with the ink tank to expand the ink containing body, thereby introducing ink from the ink tank into the ink containing body; and

regulating means capable of regulating the expansion of the ink containing body,

wherein the regulating means regulates the expansion so as to satisfy an equation

Pst=Nt

where Pst represents the negative pressure generated by the ink containing body and Nt represents an ability to hold meniscuses formed at an ink ejecting portions of the printing head.

In a fifth aspect of the present invention, there is provided an inkjet printing apparatus utilizing an ink tank capable of containing ink to be supplied to a printing head for performing printing by ejecting ink and an ink container containing an ink containing body which can contain ink therein and which can generate a negative pressure, the apparatus comprising:

means for putting the ink tank and the ink containing body in fluid communication;

means for introducing ink from the ink tank into the ink containing body in the communicated state; and

means for stopping the introduction of ink by regulating the expansion of the ink containing body with regulating means that can be displaced and for substantially achieving equilibrium between an ability to hold meniscuses formed at an ink ejecting portions of the printing head and the negative pressure generated by the ink containing body.

In a sixth aspect of the present Invention, there is provided an ink supplying method used for an inkjet printing apparatus for performing printing by using a printing head for ejecting ink, an ink tank serving as a source of ink to be supplied to the printing head, and an ink container provided halfway of an ink supply path connecting the printing head and the ink tank according to the above second aspect, the method for supplying the ink to the ink container from the ink tank, the method comprising the steps of:

establishing fluid communication between the ink tank and the ink containing body;

reducing the pressure in the inner space of the housing in the communicated state to increase the internal volume of the ink containing body and to expand the regulating member; and

canceling the depressurized state after the regulation is performed.

In a seventh aspect of the present invention, there is provided an ink supplying method used for an inkjet printing apparatus utilizing an ink tank capable of containing ink to be supplied to a printing head for performing printing by ejecting ink and an ink container containing an ink containing body which can contain ink therein and whose internal volume can be changed to generate a negative pressure, the method for supplying the ink to the ink container from the ink tank, the method comprising the steps of:

reducing the pressure in the ink container in a state in which it is in fluid communication with the ink tank to expand the ink containing body, thereby introducing ink from the ink tank into the ink containing body; and

regulating the expansion of the ink containing body by using regulating means so as to satisfy an equation

Pst=Nt

where Pst represents the negative pressure generated by the ink containing body and Nt represents an ability to hold meniscuses formed at an ink ejecting portions of the printing head.

In an eight aspect of the present invention, there is provided an ink supplying method used for an inkjet printing apparatus utilizing an ink tank capable of containing ink to be supplied to a printing head for performing printing by ejecting ink and an ink container containing an ink containing body which can contain ink therein and which can generate a negative pressure, the method for supplying the ink to the ink container from the ink tank, the method comprising the steps of:

putting the ink tank and the ink containing body in fluid communication;

introducing ink from the ink tank into the ink containing body in the communicated state; and

stopping the introduction of ink by regulating the expansion of the ink containing body with regulating means that can be displaced and for substantially achieving equilibrium between an ability to hold meniscuses formed at an ink ejecting portions of the printing head and the negative pressure generated by the ink containing body.

Incidentally, in the present specification, the wording “printing” means not only a condition of forming significant information such as characters and drawings, but also a condition of forming images, designs, patterns and the like on printing medium widely or a condition of processing the printing media, regardless of significance or unmeaning or of being actualized in such manner that a man can be perceptive through visual perception.

Further, the wording “printing medium” means not only a paper used in a conventional printing apparatus but also everything capable of accepting inks, such as fabrics, plastic films, metal plates, glasses, ceramics, wood and leathers, and in the following, will be also represented by a “sheet” or simply by “paper”.

Still further, the wording “ink” (also referred to as “liquid” in some occasions) should be interpreted in a broad sense as well as a definition of the above “printing” and thus the ink, by being applied on the printing media, shall mean a liquid to be used for forming images, designs, patterns and the like, processing the is printing medium or processing inks (for example, coagulation or encapsulation of coloring materials in the inks to be applied to the printing media).

Meantime, the present invention may be applied to a printing head in which a thermal energy generated by an electrothermal transducer is utilized to cause a film boiling to liquid in order to form bubbles, a printing head in which an electromechanical transducer is employed to eject liquid, a printing head in which a static electricity or air current is utilized to form and eject a liquid droplet and the others which are proposed in the art of an inkjet printing technology. Specifically, the printing head in which the electrothermal transducer is utilized is advantageously employed to achieve a compact structure.

Still further, the wording “nozzle”, as far as not mentioned specifically, represents to an ejection opening, a liquid passage communicated with the opening and an element for generating an energy used for ink, in summary.

The above and other objects, effects, features and advantages of the present invention will become more apparent from the following description of embodiments thereof taken in conjunction with the accompanying drawings.

### BRIEF DESCRIPTION OF THE DRAWINGS

FIG. 1 is a schematic plan view showing a general structure of an inkjet printing apparatus utilizing an intermittent supply system according to an embodiment of the invention;

FIG. 2 is a schematic side view for explaining a first example of an internal structure of a printing head unit used for the intermittent supply system in the structure in FIG. 1 and connection circuits coupled with and located around the same;

FIG. 3 is an illustration for explaining conditions such as dimensions and specifications of each part of the intermittent supply system to be satisfied to ensure that the expansion of the second ink tank will be stopped;

FIG. 4 is an illustration for explaining conditions such as dimensions and specifications of each part of the intermittent supply system to be satisfied to ensure that the expansion of the second ink tank will be stopped;

FIGS. 5A and 5B are schematic diagrams showing comparative examples of preferable structures of the intermittent supply system for reliably regulating the expansion of the second ink tank; and

FIG. 6 is a schematic diagram showing an example of a structure utilizing an air pressure type expansion regulating member for reliably regulating the expansion of the second ink tank.

### DETAILED DESCRIPTION OF THE PREFERRED EMBODIMENTS

The invention will now be described in detail with reference to the drawings.

(Example of Structure of Inkjet Printing Apparatus)

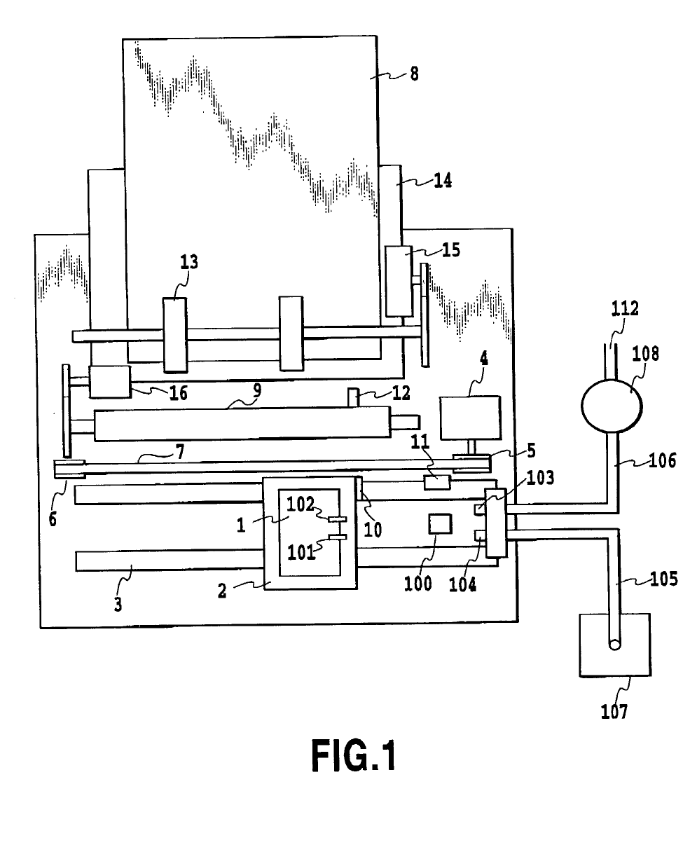

FIG. 1 is a schematic plan view showing a general structure of an inkjet printing apparatus utilizing an intermittent supply system according to an embodiment of the invention.

In the structure in FIG. 1, a printing head unit 1 is replaceably mounted on a carriage 1. The printing head unit 1 has a printing head section and a second ink tank section, and there is provided a connector (not shown) for transmitting signals such as a drive signal for driving the head section to cause an ink ejecting operation of a nozzle. The carriage 2 on which the printing head unit 1 is positioned and replaceably mounted is provided with a connector holder (electrical connecting section) for transmitting signals such as the drive signal to the printing head unit 1 through the connector.

The carriage 2 is guided and supported by a guide shaft 3 provided on a main body of the apparatus and extending in a main scanning direction such that it can be moved back and forth along the guide shaft. The carriage 2 is driven and controlled with respect to its position and movement by a main scanning motor 4 through transmission mechanisms such as a motor pulley 5, a driven pulley 6, and a timing belt 7. For example, a home position sensor 10 in the form of a transmission type photo-interrupter is provided, and a blocking plate 11 is disposed in a fixed part of the apparatus associated with a home position of the carriage such that it can block an optical axis of the transmission type photo-interrupter. Thus, when the home position sensor 10 passes through the blocking plate 11 as a result of the movement of the carriage 2, the home position is detected, and the position and movement of the carriage can be controlled using the detected position as a reference.

Printing media 8 that are printing paper or plastic sheets are separately fed one by one from an automatic sheet feeder (hereinafter referred to as an ASF) by rotating a pick-up roller 13 with an ASF motor 15 through a gear. Further, the medium is transported through a position (printing section) in a face-to-face relationship with a surface of the printing head unit 1 where ejection openings are formed as a result of the rotation of a transport roller 9 (sub scanning). The transport roller 9 is driven by transmitting the rotation of a line feed (LF) motor 16 through a gear.

At this time, judgment on whether the paper has been fed and decision of a print starting position on the printing medium in a sub scanning direction is performed based on output of a paper end sensor 12 for detecting the presence of a printing medium disposed upstream of a printing position on a printing medium transport path. The paper end sensor 12 is used to detect a rear end of a printing medium 8 and to decide a final printing position on the printing medium in the sub scanning direction based on the detection output.

The printing medium 8 is supported by a platen (not shown) at a bottom surface thereof such that a flat surface is formed in a portion thereof to be printed. In doing so, the printing head unit 1 carried by the carriage 2 is held such that the surface thereof where the ejection openings are formed protrudes downward from the carriage in parallel with the printing medium 8. For example, the printing head unit 1 is an inkjet printing head unit having a structure for ejecting ink utilizing thermal energy and having an electrothermal transducer for generating thermal energy that causes film boiling of ink. That is, the printing head of the printing head unit 1 performs printing by utilizing the pressure of bubbles generated as a result of film boiling of ink caused by the thermal energy applied by the electrothermal transducer to eject ink. Obviously, a different type of unit such as a unit that ejects ink utilizing a piezoelectric device may be used.

Reference numeral 100 represents a recovery system mechanism that has a cap member used for an operation of recovering suction of ink from the printing head unit 1 and for protecting the surface of the printing head where the ejection openings are formed. The cap member can be set in positions where it is joined to and detached from the surface where the ejection openings are formed by a motor that is not shown. Operations such as the suction recovery operation of the printing head are performed by generating a negative pressure in the cap member by a suction pump which is not shown in the joined state. The surface of the printing head where the ejection openings are formed can be protected by keeping the cap member in the joined state when the printing apparatus is not used.

Reference numeral 101 represents a valve unit provided on the printing head unit side for coupling the printing head unit 1 to an ink supply source. Reference numeral 104 represents a valve unit provided at the ink supply source side to be paired with the valve unit 101. Reference numeral 102 represents a valve unit provided on the printing head unit side for coupling the printing head unit 1 to an air pump unit. Reference numeral 103 represents a valve unit provided on an air pump unit side to be paired with the valve unit 102.

The valve units 101 through 104 are in contact and coupled with the respective valve units to allow ink and air to flow between the valve units when the carriage 2 is located at the home position outside a printing area in the main scanning direction or at a position in the vicinity of the same. The valve units are decoupled from each other when the carriage 2 moves away the position toward the printing area, and the valve units 101 and 104 automatically enter a closed state as a result of the decoupling. On the contrary, the valve unit 102 is always in an open state.

Reference numeral 105 represents a tube member that is coupled with a first ink tank 107 to supply ink to the valve unit 104. Reference numeral 106 represents a tube member for an air pressure or pneumatic circuit, the tube member being coupled with a pump unit 108 for pressurization and depressurization. Reference numeral 112 represents a suction and exhaust port of the pump unit 108. It is not essential to configure each of the tube members as an integral unit, and it may be configured by combining a plurality of tube elements.

(First Example of Structure of Intermittent Supply System)

A structure and a basic operation of an intermittent supply system of an inkjet printing apparatus according to the invention in its simplest form are described.

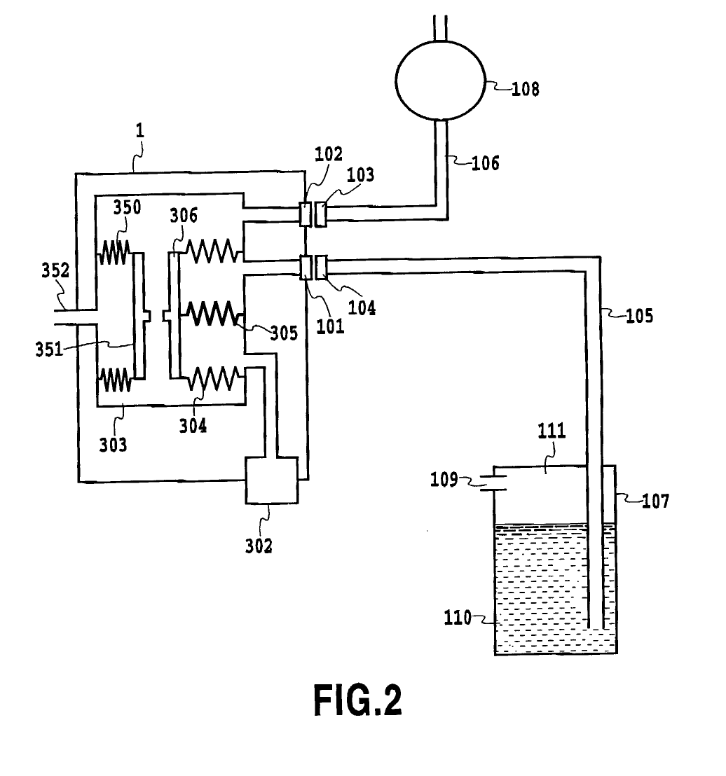

FIG. 2 is an illustration for explaining an internal structure of a printing head unit 1 used for the intermittent supply system in the structure in FIG. 1 and connection circuits coupled with and located around the same. FIG. 2 shows the printing apparatus in its attitude during use, and the upside of the figure corresponds to upside in the vertical direction.

In FIG. 2, reference numeral 302 represents a printing head on which ejection openings or nozzles are arranged in a direction different from the main scanning direction (e.g., a direction orthogonal to the same). Ejection heaters are provided in liquid paths inside the ejection openings, and each of the liquid paths are in communication with a common liquid chamber to which ink may be introduced to distribute ink in each of the liquid paths.

Reference numeral 303 represents a shell element that is a structural body for blocking communication between such an internal structure and the atmosphere in regions other than the valve units 102 and 101. Reference numeral 304 represents a second ink tank. The second ink tank 304 is constituted by a structural body which is in the form of bellows for example and which has a flexible structure that can be displaced or deformed to have a variable internal volume in accordance with the pressure in the shell element 303. The second ink tank 304 is connected to the valve unit 101 with its interior in communication with the common liquid chamber of the printing head 302. As shown in figure, in an attitude in use, the part connected to the valve unit 101 and the part in communication with the printing head 302 are in the highest and lowest positions respectively in the direction of gravity. Reference numeral 306 represents an abutting member provided at a displaced section of the structural body of the second ink tank 304.

Reference numeral 350 represents an expansion regulating member which is basically constituted by a structural body, in the form of bellows for example, which has a flexible structure that can be displaced or deformed to have a variable internal volume, like the second ink tank 304. It has an atmosphere communication port 352 for communicating the interior thereof with the atmosphere and an abutting section 351 that abuts on an abutting member 306 of the second ink tank as a result of expansion. As described later, when the valve units 102 and 103 are connected each other and then the pump unit 108 communicating those units through the tube member 106 is activated to reduce the pressure in the shell element 303, both of the second ink tank 304 and the expansion regulating member 350 expand to cause the abutting sections 306 and 351 to abut on each other, which makes it possible to regulate the expansion beyond a predetermined amount of the second ink tank 304.

Reference numeral 305 represents a compression spring that is coupled with each of the abutting member 306 of the second ink tank 304 and the shell element 303 at an end thereof and that is set such that it exerts a force in the expanding direction or the direction of increasing the internal volume of the second ink tank 304. While the spring 305 is disposed in the second ink tank 304 in the illustrated example, it may be provided outside the same. In this case, either compression spring or tension spring may be used as long as it can exert a force in the direction of increasing the internal volume of the second ink tank 304. Instead of providing such a special spring, the material and structure of the second ink tank 304 may be appropriately selected, i.e., the bellows may be constituted by a rubber member for example to provide the second ink tank 304 with a structure which generates a negative pressure therein by itself and which can be displaced or deformed in the direction of increasing the internal volume.

The interior of the second ink tank 304 is put in communication with the first ink tank 107 through the tube member 105 when the valve units 101 and 104 are connected. A space inside the shell element 303 and outside the second ink tank 304 is coupled with the pump unit 108 through the tube member 106 when the valve units 102 and 103 are connected. The valve units 101 and 104 have a structure in which they form an ink channel a fluid path when coupled with each other and close the same in an uncoupled state. Unlike such valve units 101 and 104, the valve units 102 and 103 have no valve member to close the channel when they are disconnected. In particular, the space inside the shell member 303 and outside the second ink tank 304 is exposed to the atmosphere when they are disconnected.

The pump unit 108 may have a pump main body in the form of a diaphragm pump, for example, and a directional control valve which is connected to an action chamber of the pump main body and which can switch a channel between the atmosphere and the valve unit 103. In the coupled state of the valve units 102 and 103, the pressure in the shell element 303 can be increased by first performing a sucking operation with the channel set in the position of the atmosphere and then performing an ejecting operation with the channel set in the position of the valve unit or shell element. Conversely, the pressure in the shell element 303 can be reduced by performing a suction operation with the channel set in the position of the valve unit or shell element and then performing an ejecting operation with the channel set in the position of the atmosphere. Obviously, the pump unit 108 may have any structure as long as it can appropriately increase or reduce the pressure in the shell element 303. Essential parts of the invention are aimed at performing the process of charging the second ink tank 304 with ink from the first ink tank 107 efficiently, and the pump unit 108 may obviously have a structure for performing only an air sucking operation from the shell element 303 if it is used for only the process of reducing the pressure inside the shell element 303 for the charging operation. Further, while depressurization is carried out by sucking air from the shell element 303 using the pump unit 108 in the present embodiment, a predetermined gas or liquid may alternatively be enclosed in the shell element 303 and a depressurizing force may be applied to the same.

While various structures are possible for the first ink tank 107 for reserving ink 110 to be supplied to the second ink tank 304 or printing head 302, the tank in the present embodiment has an atmosphere communication section 109 to always keep the pressure therein at the atmospheric pressure through communication with the atmosphere. While the atmosphere communication section 109 may be a simple hole as long as it is in a position higher than the ink level, the hole may be provided with a functional film that allows only gases to pass and disallows liquids to pass from the viewpoint of more effective prevention of leakage of ink. The tip of the tube member 105 that is stuck into the first ink tank to transport ink is located at its lowest position in the ink tank in the direction of gravity in the attitude in use as illustrated. This structure is advantageous in using up ink without any residue.

In the structure of the present embodiment, the first ink tank 107 and the second ink tank 304 have no sponge such that ink is contained in the spaces therein as it is. This provides a structure in which ink and a gas can be quickly separated from each other downward and upward respectively in the direction of gravity without any obstacle.

(Ink Charging Process)

A process for charging ink from the first ink tank 107 to the second ink tank 304 in the above structure will be described.

In ink charging process, a capping operation is first performed. This is an operation of moving the cap section of the recovery system mechanism indicated by reference numeral 100 in FIG. 1 to put it in tight contact with the surface of the printing head 302 in FIG. 2 where the ejection openings are formed, thereby forming a closed system in that part.

Next, the carriage 2 is moved in the main scanning direction in the structure in FIG. 1 to cause the valve units 101 and 102 to abut on the corresponding valve units 104 and 103 for connecting, thereby forming an ink channel and an air channel. The invention is not limited to this method of connection. The channels in the valve units 101 and 104 are closed until they are connected, and both of the channels are opened and coupled with each other at the time of connection. The valve units 102 and 103 are always open, and an air channel is formed as they are coupled.

Then, the pump unit 108 is operated for depressurization. Since the pressure in the shell element 303 becomes lower than the atmospheric pressure as a result of the depressurizing operation of the pump unit 108, the second ink tank 304 expands to cause ink to flow from the first ink tank 107 into the second ink tank 304 through the tube member 105 and the valve units 104 and 101. At the same time, the expansion regulating member 350 also expands because outside air flows into the expansion regulating member 350 through the atmosphere communication port 352. When the depressurizing operation is continued for a predetermined time, the abutting member 306 of the second ink tank 304 and the abutting section 351 of the expansion regulating member 350 finally abut on each other, and any further expansion of the second ink tank 304 is prevented by the abutment of them.

Before the depressurizing operation is canceled, the carriage 2 is moved toward the printing area in the main scanning direction to decouple the valve units At this time, both of the valve units 101 and 104 operate to close the channel, and the valve unit 102 is left in the open state. Finally, the capped state provided by the recovery system mechanism 100 is canceled to terminate the process.

In a structure in which a fixed stopper is provided in the shell element 303 instead of the expansion regulating member 350 and in which the ink charging operation is completed with the abutting member 306 of the second ink tank 304 abutting on the fixed stopper, the compression spring 305 cannot freely extend, i.e., it cannot apply an adequate negative pressure to the printing head 302 as it is. In such a structure, an additional operation is performed in which pressurization is performed for a short time after depressurization for charging to push a small amount of ink in the second ink tank 304 back to the first ink tank 107 and in which the second ink tank 304 is thus contracted to space the abutting member 306 from the stopper 307, thereby allowing an adequate negative pressure to be generated by the compression spring 305.

In this example, however, the structures of the second ink tank 304 and the expansion regulating member 350 are appropriately defined such that the valve units are disconnected after that the operation of charging the second ink tank 304 with ink is completed as a result of the abutment between the second ink tank 304 and the expansion regulating member 350, to expose the interior of the shell element 303 to the atmosphere; the expansion regulating member 350 in communication with the atmosphere is thus allowed to contract while allowing the compression spring 305 to expand when the depressurizing operation is stopped; and the second ink tank 304 is thus allowed to generate an adequate negative pressure. That is, the compression spring 305 is allowed to be displaced in the direction of increasing the internal volume of the second ink tank 304 after the charging operation is completed such that the expansion of the second ink tank 304 stops when it is balanced against a meniscus holding ability of the printing head. This makes it possible to reduce the time required for enabling printing.

The spring constant of the compression spring 305 is desirably set such that the negative pressure is maintained in a range of optimum values at which ink can be ejected from the printing head properly from this state until the internal volume of the second ink tank 304 is minimized as a result of the consumption of ink.

In the event that air enters in the second ink tank 304, the air is tempted to expand in response to a temperature rise. When the ink charging operation has then proceeded to disallow any further expansion of the second ink tank 304, a problem can arise in that the internal pressure of the second ink tank increases to cause ink to leak through the ejection openings. It is therefore desirable to limit the ink charging operation to a such range that the second ink tank itself can still expand in order to allow the expansion of air, the expansion regulating member 350 is used to ensure that the expansion of the second ink tank 304 is stopped at a predetermined position for this reason too.

The above structure and process make it possible to supply ink to the second ink tank intermittently in a simple manner without generating any waste ink as a result of a charging operation.

A structure is employed with which the internal volume of the second ink tank 304 can be varied to generate an adequate negative pressure, and the second ink tank 304 itself functions as an actuator for charging ink by varying the internal volume thereof, by which those operations can be achieved by driving and controlling a single source of driving.

Although a capping operation is performed at the beginning of the above ink charging process, the capping operation may be omitted when fluctuations of the pressure in the second ink tank 304 determined by the rate of expansion of the second ink tank 304 and the relationship between ink channel resistances of the first ink tank 107 and the second ink tank 304 are smaller than the meniscus holding pressure of the ejection openings. Such an alternative may be taken when the rate of expansion is low because of a low ink flow rate and when the resistances of the channels are small because of great channel sectional areas, for example.

(Specifications of Intermittent Supply System)

A description will now be made on conditions such as dimensions and specifications of each part of the intermittent supply system to be satisfied to ensure the stoppage.

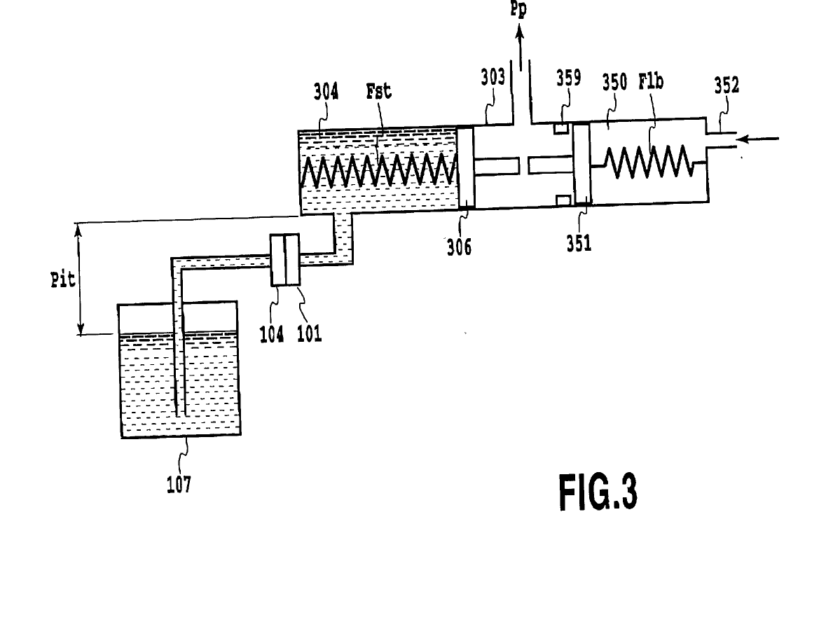

FIG. 3 shows a model of the structure in FIG. 2. A left part of a shell element 303 shown as having a cylindrical shape corresponding to the second ink tank 304, a right part of the same corresponding to the expansion regulating member 350. A space located between those parts is in communication with the pump unit 108, and a pressure Pp is applied to the same as a result of a depressurizing operation. Fst represents a composite spring force provided by the second ink tank 304 itself and the compression spring 305. Flb represents a spring force of the expansion regulating member 350 itself, the force acting in the direction of contracting the expansion regulating member. A pressure that is applied to the second ink tank 304 in accordance with the relationship between the heights of the first ink tank 107 and the second ink tank 304 (the difference between the head heights)is represented by Pit.

Pressure bearing areas of the abutting member 306 of the second ink tank 304 and the abutting section 351 of the expansion regulating member 350 are represented by Ast and Alb, respectively. When the second ink tank 304 is expanded by the depressurizing operation of the pump unit 108, the abutting member 306 of the second ink tank 304 is moved rightward in the figure by a force applied thereto that is expressed by:

(Pp×Ast)+Fst+(Pit×Ast)

The abutting section 351 of the expansion regulating member 350 is moved leftward in the figure by a force applied thereto that is expressed by:

(Pp×Alb)−Flb

In order for the abutting sections to abut on each other and to stop in such a state, the following condition must be satisfied.

(Pp×Ast)+Fst+(Pit×Ast)=(Pp×Alb)−Flb Equation 1

The expansion of the second ink tank 304 is regulated in an adequate position to complete ink charging if conditions such as the dimensions and specifications of each part are determined such that the above condition is satisfied.

However, in order to regulate the expansion of the second ink tank 304 with reliability, the following relationship is preferably satisfied:

(Pp×Ast)+Fst+(Pit×Ast)<(Pp×Alb)−Flb Equation 2

That is, the force exerted by the abutting section 351 of the expansion regulating member 350 is preferably greater than the force exerted by the abutting member 306 of the second ink tank 304. It is also preferable to provide a stopper 359 for limiting the movement of the abutting section 351 of the expansion regulating member 350 at a predetermined position in order to prevent the second ink tank 304 from contracting in an undesirable amount after the abutment.

When the ink channel to the first ink tank 107 is blocked to cancel depressurization after stability is achieved in the stopped state, since only the composite spring force Fst originating from the second ink tank 304 itself and the compression spring 305 acts, the pressure in the second ink tank 304 (the negative pressure relative to the printing head) Pst is expressed as follows;

Pst=−Fst/Ast Equation 3

It is therefore desirable that the composite spring force of the second ink tank 304 itself and the compression spring 305, in particular, the spring constant of the compression spring 305 is set such that ink meniscuses at the ejection openings are held regardless of the attitude or orientation of the printing apparatus and such that a negative pressure in a range of optimum values at which ink can be properly ejected from the printing head is maintained from the ink charged state until the internal volume of the second ink tank 304 is minimized as a result of the consumption of ink. That is, it is desirable that a relationship expressed by Pst=Nt is satisfied where Nt represents the ink meniscus holding ability.

The values in Equation 2 may be determined based on the relationship among the factors. For example, the areas of the inner surfaces of the abutting sections 306 and 351 may be determined according to the negative pressure to be applied to the printing head, the head difference between the second ink tank 304 and the first ink tank 107, the pressure for depressurization, and the spring force.

This will be described with specific numerical values.

Providing to neglect the spring force Flb of the expansion regulating member 350 itself in the direction of contacting the same that is assumed to be very small and providing to substitute the relationship expressed by Equation 3 in Equation 2. Then, Equation 2 is changed as follows:

Pp×Alb>(Pp−Pst+Pit)×Ast Equation4

It is assumed that the first ink tank 107 is located lower than the second ink tank 304 in the direction of gravity to apply a pressure Pit=−0.7 KPa, for example, to the second ink tank 304 in the example of structure in FIG. 2 and the model in FIG. 3. It is assumed further that a pressure Pp=30 KPa is applied to the interior of the shell element 303 through the depressurizing operation performed by the pump unit 108. It is assumed further assume that a negative pressure Pst=−1 KPa is exerted by the second ink tank 304. Then, those values are substituted in Equation 4, the calculation of which indicates that the area Alb of the inner surface of the abutting section 351 of the expansion regulating member 350 may be greater than about 1.01 times the area Ast of the inner surface of the abutting member 306 of the second ink tank 304.

That is, when the difference Pp×(Alb−Ast) between the forces exerted by the expansion regulating member 350 and the second ink tank 304 is relatively large, the influence of a force originating from the head difference of the first ink tank 107 can be substantially cancelled.

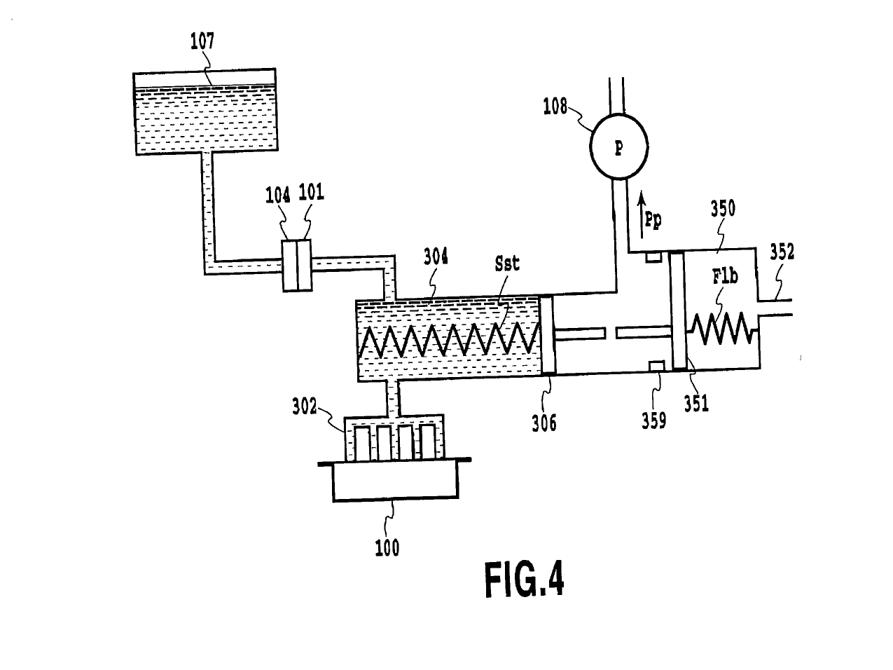

A case will now be discussed in which the first ink tank 107 is located higher than the second ink tank 304 in the direction of gravity as shown in FIG. 4. In this case, it is assumed that a pressure Pit=+0.5 KPa is applied to the second ink tank 304, for example. Let us assume further that a pressure Pp=30 KPa is applied to the interior of the shell element 303 through the depressurizing operation performed by the pump unit 108. Let us further assume that a negative pressure Pst=−1 KPa is exerted by the second ink tank 304. Then, those values are substituted in Equation 4, the calculation of which indicates that the area Alb of the inner surface of the abutting section 351 of the expansion regulating member 350 may be greater than about 1.05 times the area Ast of the inner surface of the abutting member 306 of the second ink tank 304 and that the capability of canceling the influence of the pressure in the first ink tank is improved by increasing the difference between the areas.

By determining the dimensions of the second ink tank 304 and the expansion regulating member 350 as described above, the expansion of the second ink tank 304 can be reliably stopped by the expansion regulating member 350 in an appropriate position regardless of the pressure Pit applied to the second ink tank 304 according to the head difference between the second ink tank 304 and the first ink tank 107.

(Examples of Structures of Second Ink Tank and Air Pressure Type Expansion Regulating Member)

In order to stop the second ink tank 304 with reliability as described above, the structures of the second ink tank 304 expanding as a result of a reduction of the pressure in the shell element 303 and the expansion regulating member 350 is appropriately determined.

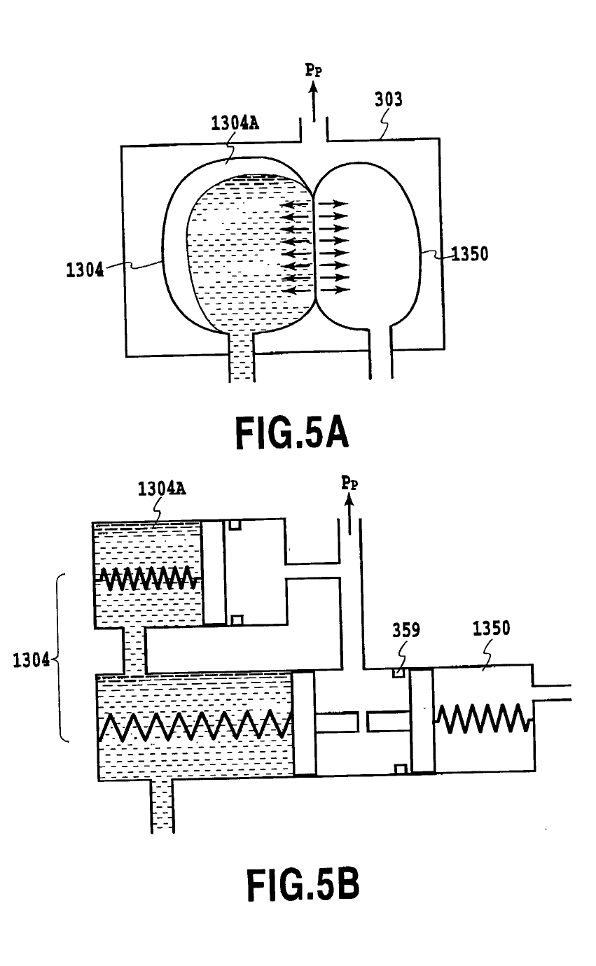

For example, when a second ink tank 1304 and an expansion regulating member 1350 each having a bag-like structure that is simply in the form of a balloon are adopted as shown in FIG. 5A, they have equal contact areas when they abut on each other, and it is difficult to regulate the expansion of the second ink tank 1304 in an appropriate position with stability. Further, the influence of a relative head difference between them cannot be eliminated depending on the position of the first ink tank 107, which makes the regulation of expansion more difficult.

Further, since parts of the second ink tank 1304 that are not in contact with the expansion regulating member 1350 also expand in the gap between the shell element 303, as shown in a model in FIG. 5B, the pressure in the second ink tank 1304 after the cancellation of a depressurizing operation includes the pressure in such expanding parts 1304A added thereto, which disallows the generation of a negative pressure that is adequate for the printing head 302 and may rather result in a positive pressure. A problem arises in that the positions and structures of the stopper 359 and the member to regulate the expansion of the second ink tank 1304 as a whole must be precisely determined in order to prevent this.

In this regard, it is effective to provide the second ink tank 304 and the expansion regulating member 350 with a structure in the form of bellows whose expanding direction is linearly regulated and to form the displaced sections as abutting sections in the form of flat plates, as shown in FIGS. 2 and 3 or FIG. 4. It is also preferable to form rods in the section such that parts acting as centers of application of pressures abut on each other.

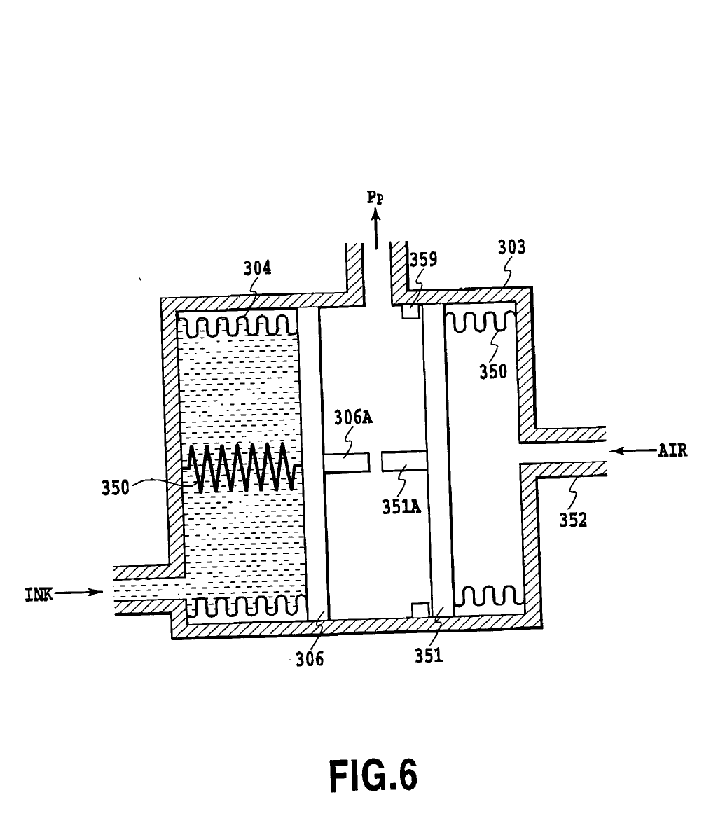

FIG. 6 schematically shows such a structure. Specifically, it shows a structure in which a second ink tank 304 and an expansion regulating member 350 in the form of bellows having appropriately defined specifications such as dimensions and positions are provided in a shell element 303 and in which rods 306A and 351A are provided in parts of abutting sections 306 and 350 in the form of flat plates that abut on each other. Further, in order to prevent the second ink tank 304 from contracting in an undesirable amount after the abutment, a stopper 359 is provided to limit the movement of the abutting section 351 of the expansion regulating member 350 to a predetermined position.

As described above, the invention makes it possible to provide a structure in which an intermittent supply system is adopted as an ink supply system; a second ink tank is charged with ink with high efficiency in a short charging time; and ink is used with high efficiency as a whole. The invention thus contributes to the structure of a compact and portable inkjet printing apparatus.

The present invention has been described in detail with respect to preferred embodiments, and it will now be apparent from the foregoing to those skilled in the art that changes and modifications may be made without departing from the invention in its broader aspects, and it is the intention, therefore, in the appended claims to cover all such changes and modifications as fall within the true spirit of the invention.

What is claimed is:

1. An ink container that can be disposed halfway of an ink supply path connecting a printing head for performing printing by ejecting ink and an ink tank serving as a source of ink to be supplied to said printing head, comprising:
an ink containing body capable of containing ink introduced thereto from said ink tank in a state in which it is in fluid communication with said ink tank, said ink containing body supplying the ink contained therein to said printing head during printing and having a flexible structure whose internal volume can be increased as a result of expansion to introduce ink therein and which can generate a negative pressure;
a housing having an inner space in which a pressure can be adjusted, said housing allowing said ink containing body to be contained in the space and allowing the expansion thereof in accordance with depressurization; and
regulating means provided in said housing such that it can regulate the expansion of said ink containing body,
wherein said regulating means is configured to regulate the expansion so as to satisfy an equation:
Pst =Nt
where Pst represents the negative pressure generated by said ink containing body and Nt represents an ability to hold meniscuses formed at an ink ejecting portions of said printing head.

2. An ink container as claimed in claim 1, wherein the regulation performed by said regulating means is cancelled to allow said ink containing body to expand and generate the negative pressure, thereby satisfying said equation.

3. An ink container as claimed in claim 2, wherein said ink containing body has a member having an end attached to an inner wall of said housing and another end that can be displaced according to the expansion; said member can be put in fluid communication with said ink tank through channel extending through said wall of said housing and the end; and an abutting section whose displacement is regulated by said regulating means is provided at the other end.

4. An ink container as claimed in claim 3, wherein said ink containing body is provided with a spring for generating the negative pressure by urging the other end of said member in the direction of expanding of said member.

5. An ink container as claimed in claim 4, wherein said regulating means has a regulating member which can expand to a predetermined position according to depressurization of the inner space of said housing and which abuts on said abutting section of said ink containing body as a result of the expansion to regulate the displacement of the same.

6. An ink container as claimed in claim 5; wherein said regulating member has a member having an end attached to an inner wall of said housing and another end that can be displaced according to the expansion; said member is in communication with the atmosphere through an atmosphere communication section extending through said wall of said housing and the end; and an abutting section that abuts on the part is provided at the other end.

7. An ink container as claimed in claim 6, wherein an equation
Ast<Alb
is satisfied where Ast and Alb represent pressure bearing areas of said abutting section of said ink containing body and said abutting section of said expansion regulating member, respectively.

8. An ink container as claimed in claim 7, wherein an equation
(Pp×Ast)+Fst+(Pit×Ast)<(Pp×Alb)−Flb
is satisfied where Pp represents a pressure acting in said housing as a result of the depressurizing operation; Fst represents a force urging said ink containing body in the expanding direction; Flb represents a force acting in the direction of contracting said regulating member; and Pit represents, a pressure acting on said ink containing body in accordance with the relationship between the heights of said ink containing body and said ink tank.

9. An ink container as claimed in claim 1, having a configuration in which it is directly connected to said printing head.

10. An inkjet printing apparatus for performing printing by using a printing head for ejecting ink, an ink tank serving as a source of ink to be supplied to said printing head, and an ink container provided halfway of an ink supply path connecting said printing head and said ink tank as claimed in claim 5, said apparatus comprising:
channel opening and closing means for establishing and blocking fluid communication between said ink tank and said ink containing body; and
pressure adjusting means for reducing the pressure in the inner space of said housing in the communicated state to increase the internal volume of said ink containing body and to expand said regulating member and for canceling the depressurized state after the regulation is performed.

11. An inkjet printing apparatus as claimed in claim 10, wherein said channel opening and closing means blocks said channel when the pressure adjusting means cancels the depressurization.

12. An inkjet printing apparatus utilizing an ink tank capable of containing ink to be supplied to a printing head for performing printing by ejecting ink and an ink container containing an ink containing body which can contain ink therein and whose internal volume can be changed to generate a negative pressure, said apparatus comprising:
pressure adjusting means for reducing the pressure in said ink container in a state in which it is in fluid communication with said ink tank to expand said ink containing body, thereby introducing ink from said ink tank into said ink containing body; and
regulating means capable of regulating the expansion of said ink containing body,
wherein said regulating means regulates the expansion so as to satisfy an equation
Pst=Nt
where Pst represents the negative pressure generated by said ink containing body and Nt represents an ability to hold meniscuses formed at an ink ejecting portions of said printing head.

13. An inkjet printing apparatus as claimed in claim 12, wherein the regulation performed by said regulating means is cancelled to allow said ink containing body to expand and generate the negative pressure, thereby satisfying said equation.

14. An inkjet printing apparatus utilizing an ink tank capable of containing ink to be supplied to a printing head for performing printing by ejecting ink and an ink container containing an ink containing body which can contain ink therein and which can generate a negative pressure, said apparatus comprising:
means for putting said ink tank and said ink containing body in fluid communication;
means for introducing ink from said ink tank into said ink containing body in the communicated state; and
means for stopping the introduction of ink by regulating the expansion of said ink containing body with regulating means that can be displaced and for substantially achieving equilibrium between an ability to hold meniscuses formed at an ink ejecting portions of said printing head and the negative pressure generated by said ink containing body.

15. An inkjet printing apparatus as claimed in claim 14, wherein the regulation performed by said regulating means is canceled to allow said ink containing body to expand and to generate the negative pressure, thereby satisfying conditions to substantially achieve the equilibrium.

16. An inkjet printing apparatus as claimed in claim 12, wherein said ink container is provided halfway of an ink supply path connecting said ink tank and said printing head.

17. An inkjet printing apparatus as claimed in claim 12, wherein said printing head and said ink container are integrally formed.

18. A printing apparatus as claimed in claim 12, wherein said printing head has a heating element for generating thermal energy that causes film boiling of ink as energy used to eject the ink.

19. An ink supplying method used for an inkjet printing apparatus for performing printing by using a printing head for ejecting ink, an ink tank serving as a source of ink to be supplied to said printing head, and an ink container provided halfway of an ink supply path connecting said printing head and said ink tank as claimed in claim 5, said method for supplying the ink to said ink container from said ink tank, said method comprising the steps of:
establishing fluid communication between said ink tank and said ink containing body:
reducing the pressure in the inner space of said housing in the communicated state to increase the internal volume of said ink containing body and to expand said regulating member; and
canceling the depressurized state after the regulation is performed.

20. An ink supplying method as claimed in claim 19, further comprising the step of blocking said channel when said pressure adjusting means cancels the depressurization.

21. An ink supplying method used for an inkjet printing apparatus utilizing an ink tank capable of containing ink to be supplied to a printing head for performing printing by ejecting ink and an ink container containing an ink containing body which can contain ink therein and whose internal volume can be changed to generate a negative pressure, said method for supplying the ink to said ink container from said ink tank, said method comprising the steps of:
reducing the pressure in said ink container in a state in which it is in fluid communication with said ink tank to expand said ink containing body, thereby introducing ink from said ink tank into said ink containing body; and
regulating the expansion of said ink containing body by using regulating means so as to satisfy an equation
Pst=Nt
where Pst represents the negative pressure generated by said ink containing body and Nt represents an ability to hold meniscuses formed at an ink ejecting portions of said printing head.

22. An ink supplying method as claimed in claim 21, wherein the regulation performed by said regulating means is cancelled to allow said ink containing body to expand and generate the negative pressure, thereby satisfying said equations.

23. An ink supplying method used for an inkjet printing apparatus utilizing an ink tank capable of containing ink to be supplied to a printing head for performing printing by ejecting ink and an ink container containing an ink containing body which can contain ink therein and which can generate a negative pressure, said method for supplying the ink to said ink container from said ink tank, said method comprising the steps of:
putting said ink tank and said ink containing body in fluid communication;
introducing ink from said ink tank into said ink containing body in the communicated state; and
stopping the introduction of ink by regulating the expansion of said ink containing body with regulating means that can be displaced and for substantially achieving equilibrium between an ability to hold meniscuses formed at an ink ejecting portions of said printing head and the negative pressure generated by said ink containing body.

24. An ink supplying method as claimed in claim 23, wherein the regulation performed by said regulating means is canceled to allow said ink containing body to expand and to generate the negative pressure, thereby satisfying conditions to substantially achieve the equilibrium.
